(19) United States
(12) Patent Application Publication
(10) Pub. No.: US 2016/0209918 A1
(43) Pub. Date: Jul. 21, 2016

(54) ELECTRONIC APPARATUS AND METHOD

(71) Applicant: KABUSHIKI KAISHA TOSHIBA, Tokyo (JP)

(72) Inventor: Satoshi Takezaki, Ome Tokyo (JP)

(21) Appl. No.: 14/886,555

(22) Filed: Oct. 19, 2015

Related U.S. Application Data
(60) Provisional application No. 62/104,488, filed on Jan. 16, 2015.

(51) Int. Cl. G06F 3/01; G06F 3/033

(52) U.S. Cl. CPC G06F 3/013; G06F 3/033

(57) ABSTRACT

According to one embodiment, an electronic apparatus including a first user interface to accept input by a sight line of a user is provided. The electronic apparatus includes a display and a circuitry configured to accept a position on a screen of the display corresponding to the sight line of the user as the input, and display a cursor operated based on the sight line of the user at the accepted position on the screen. The cursor is configured to be operated independently of an operation to a second user interface of an operating system which runs on the electronic apparatus. The circuitry is further configured to notify a state of the first user interface by changing a display mode of the cursor.

### CROSS-REFERENCE TO RELATED APPLICATIONS

This application claims the benefit of U.S. Provisional Application No. 62/104,488, filed Jan. 16, 2015, the entire contents of which are incorporated herein by reference.

### FIELD

Embodiments described herein relate generally to an electronic apparatus and a method.

### BACKGROUND

Generally, for example, various electronic apparatus such as notebook or desktop personal computers and tablet computers are known.

To further improve operability in such electronic apparatuses, recently a user interface (hereinafter referred to as a sight line input UI) that allows input by a sight line of a user has been developed.

In the sight line input UI, a position on a display screen corresponding to the sight line of the user can be accepted as the input by the sight line of the user, by using an imaging device such as a camera. Therefore, the user can give various instructions to the electronic apparatus by looking at the display screen.

When using the sight line input UI, however, it is difficult for the user to understand where an instruction is accepted on the screen and whether an intended instruction has been correctly accepted.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of the appearance of an electronic apparatus of a present embodiment.

FIG. 2 is a diagram showing an example of a system configuration of the electronic apparatus.

FIG. 3 is a diagram showing an example of a functional structure of a sight line input UI program.

FIG. 4 is a flowchart showing an example of a procedure in the case where the sight line input UI is provided in the electronic apparatus.

FIG. 5 is a view specifically illustrating a sight line input UI cursor.

FIG. 6 is a flowchart showing an example of a procedure to compute a calibration value.

FIG. 7 is a view illustrating a case where there is no error between a sight line position specified by a sight line detector and the position on a display screen that the user is actually looking at.

FIG. 8 is a view illustrating a case where there is an error between the sight line position specified by the sight line detector and the position on the display screen that the user is actually looking at.

### DETAILED DESCRIPTION

Various embodiments will be described hereinafter with reference to the accompanying drawings.

In general, according to one embodiment, an electronic apparatus including a first user interface to accept input by a sight line of a user is provided. The electronic apparatus includes a display and a circuitry configured to accept a position on a screen of the display corresponding to the sight line of the user as the input, and display a cursor operated based on the sight line of the user at the accepted position on the screen. The cursor is configured to be operated independently of an operation to a second user interface of an operating system which runs on the electronic apparatus. The circuitry is further configured to notify a state of the first user interface by changing a display mode of the cursor.

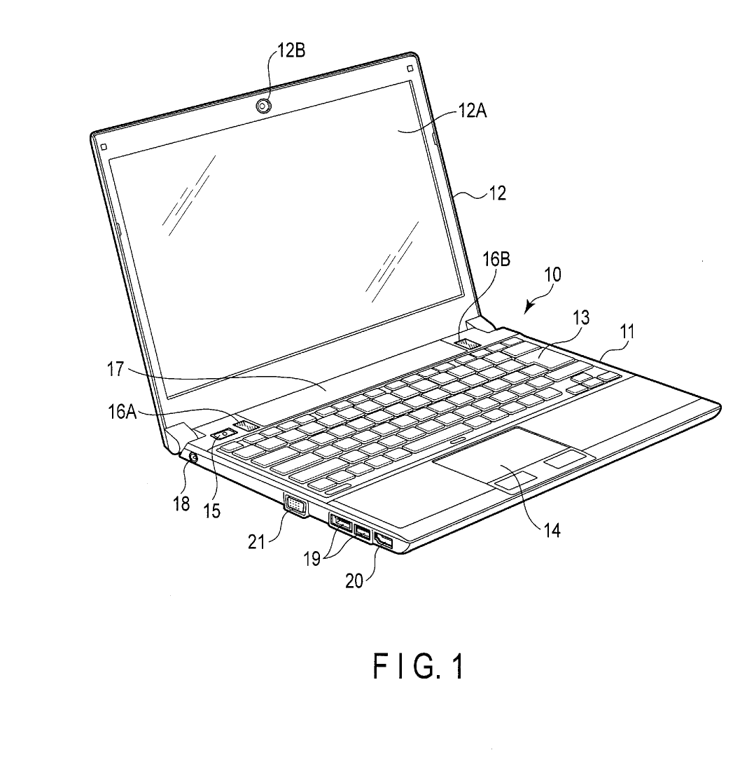

FIG. 1 is a perspective view showing the appearance of an electronic apparatus of a present embodiment. The electronic apparatus may be implemented as various electronic apparatuses used by the user such as a notebook or desktop personal computer (PC), a tablet computer or the like. In FIG. 1, the electronic apparatus is assumed to be implemented as, for example, a notebook personal computer. In the description below, the electronic apparatus of the present embodiment is assumed to be implemented as a notebook personal computer.

As shown in FIG. 1, an electronic apparatus 10 includes an electronic apparatus body (computer body) 11 and a display unit 12.

The electronic apparatus body 11 has a thin box-shaped housing. The display unit 12 is attached to the electronic apparatus body 11. The display unit 12 is rotatable between an open position in which the top surface of the electronic apparatus body 11 is exposed and a close position in which the top surface of the electronic apparatus body 11 is covered with the display unit 12.

A display device such as a liquid crystal display device (LCD) 12A is incorporated into the display unit 12.

In addition, an imaging device 12B such as a camera is provided on the upper portion of the display unit 12. The imaging device 12B is used to detect a sight line of a user using the electronic apparatus 10, and is provided at a position where the eyes of the user using the electronic apparatus 10 can be imaged. As the imaging device 12B, an infrared camera including a function of imaging infrared radiation is used. It should be noted that a visible light camera (for example, a web camera) including a function of imaging visible light may also be used as the imaging device 12B.

A keyboard 13, a touchpad 14, a power switch 15 to power on and off the electronic apparatus 10, speakers 16A and 16B, etc., are arranged on the top surface of the electronic apparatus body 11.

The electronic apparatus 10 is supplied with power from the battery 17. In the example of FIG. 1, the battery 17 is built in, for example, the electronic apparatus 10.

A power connector (DC power input terminal) 18 is further provided in the electronic apparatus body 11. The power connector 18 is provided on the side surface, for example, the left side surface of the electronic apparatus body 11. An external power unit is connected to the power connector 18 so as to be detachable. As the external power unit, an AC adapter can be used. The AC adapter is a power unit that converts commercial power (AC power) to DC power.

The electronic apparatus 10 is driven by the power supplied from the battery 17 or the external power unit. When the external power unit is not connected to the power connector 18 of the electronic apparatus 10, the electronic apparatus 10 is driven by the power supplied from the battery 17. On the other hand, when the external power unit is connected to the power connector 18 of the electronic apparatus 10, the electronic apparatus 10 is driven by the power supplied from the external power unit. The power supplied from the external power unit is also used to charge the battery 17.

For example, a plurality of USB ports 19, a high-definition multimedia interface (HDMI) (registered trademark) output terminal 20 and an RGB port 21 are further provided in the electronic apparatus body 11.

The touchpad 14 is used as a pointing device in the electronic apparatus 10, but a mouse connected via the USB port 19 may also be used as a pointing device.

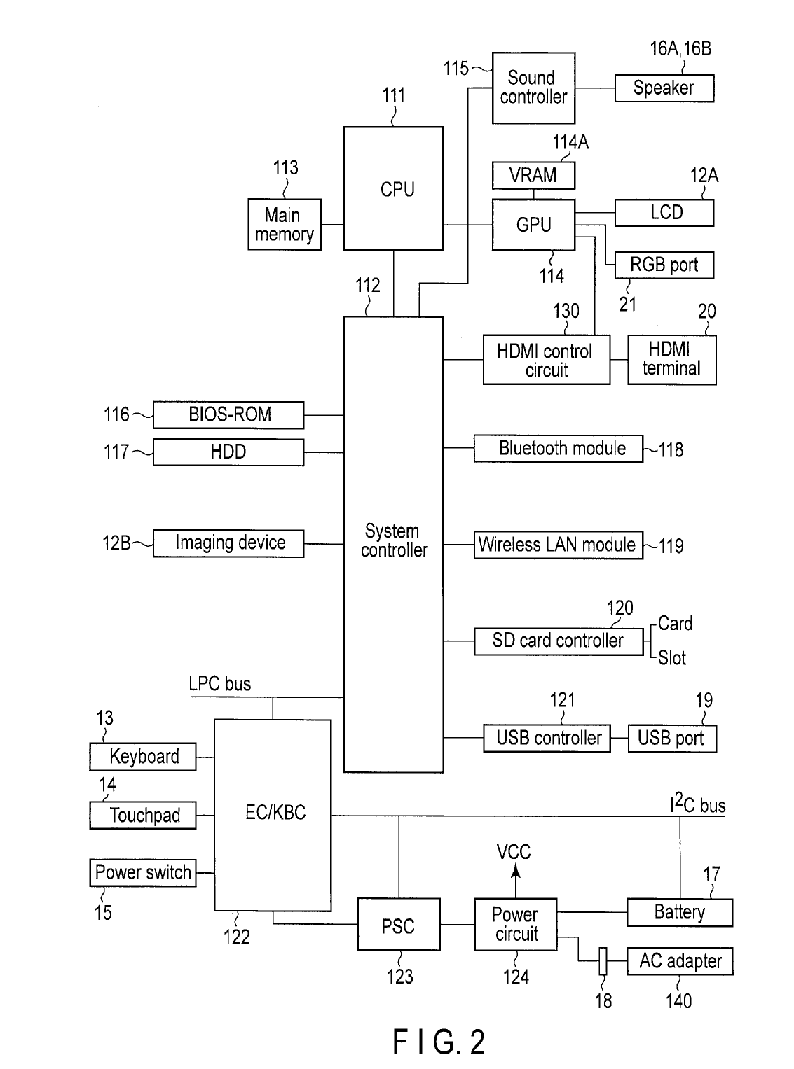

FIG. 2 shows a system configuration of the electronic apparatus 10 shown in FIG. 1. The electronic apparatus 10 includes a CPU 111, a system controller 112, a main memory 113, a graphics processing unit (GPU) 114, a sound controller 115, a BIOS-ROM 116, a hard disk drive (HDD) 117, a Bluetooth (registered trademark) module 118, a wireless LAN module 119, an SD card controller 120, a USB controller 121, an embedded controller/keyboard controller IC (EC/KBC) 122, a power supply controller (PSC) 123, a power circuit 124, etc.

The CPU 111 is a processor configured to control operations of each component of the electronic apparatus 10. The processor includes a processor circuitry. The CPU 111 executes various computer programs loaded from a storage device such as the HDD 117 to the main memory 113. The computer programs include the operating system (OS), a program (hereinafter referred to as a sight line input UI program) to provide a user interface (hereinafter referred to as a sight line input UI) to accept input by a sight line of the user, and other application programs. The sight line input UI is independent of (the user interface of) the OS and does not depend on, for example, the state transition of the OS, which will be described later.

The CPU 111 also executes a basic input/output system (BIOS) stored in the BIOS-ROM 116 which is a nonvolatile memory. The BIOS is a system program for hardware control.

The system controller 112 is a bridge device configured to connect the CPU 111 to each component. The system controller 112 is equipped with a serial ATA controller to control the HDD 117. In addition, the system controller 112 communicates with each device on a Low PIN Count (LPC) bus.

The GPU 114 is a display controller configured to control the LCD 12A used as a display monitor of the electronic apparatus 10. The GPU 114 generates a display signal (LVDS signal) to be supplied to the LCD 12A from display data stored in a video memory (VRAM) 114A.

The GPU 114 can also generate an HDMI video signal and an analog RGB signal from the display data. The HDMI output terminal 20 can transmit the HDMI video signal (uncompressed digital video signal) and a digital audio signal to an external display via a cable. The analog RGB signal is supplied to the external display via the RGB port 21.

An HDMI control circuit 130 shown in FIG. 2 is an interface configured to transmit the HDMI video signal and the digital audio signal to the external display via the HDMI output terminal 20.

The sound controller 115 is a sound device and outputs audio data to be reproduced to, for example, the speakers 16A and 16B.

The Bluetooth module 118 is a module configured to execute wireless communication with a Bluetooth-compatible device by using Bluetooth.

The wireless LAN module 119 is a module configured to execute wireless communication conforming to, for example, the IEEE 802.11 standard.

The SD card controller 120 writes data to and reads data from a memory card inserted into a card slot provided in the electronic apparatus body 11.

The USB controller 121 communicates with an external device connected via the USB port 19.

The EC/KBC 122 is connected to the LPC bus. The EC/KBC 122 interconnects with the PSC 123 and the battery 17 via a serial bus such as an I²C bus.

The EC/KBC 122 is a power management controller configured to execute power management of the electronic apparatus 10, and is implemented as, for example, a one-chip microcomputer equipped with a keyboard controller that controls the keyboard (KB) 13 and the touchpad 14. The EC/KBC 122 includes a function of powering on and off the electronic apparatus 10 in response to an operation of the power supply switch 15 by the user. The power-on and power-off of the electronic apparatus 10 are controlled by the EC/KBC 122 and the PSC 123 in combination. When an ON signal transmitted from the EC/KBC 122 is received, the PSC 123 controls the power circuit 124 to power on the electronic apparatus 10. When an OFF signal transmitted from the EC/KBC 122 is received, the PSC 123 controls the power circuit 124 to power off the electronic apparatus 10.

The power circuit 124 generates power (operating power Vcc) to be supplied to each component by using the power supplied from the battery 17 or the power supplied from the AC adapter 140 connected to the electronic apparatus body 11 as the external power unit.

The imaging device 12B shown in FIG. 1 is connected to the system controller 112. An image captured by the imaging device 12B is used to accept input by a sight line of the user in the sight line input UI.

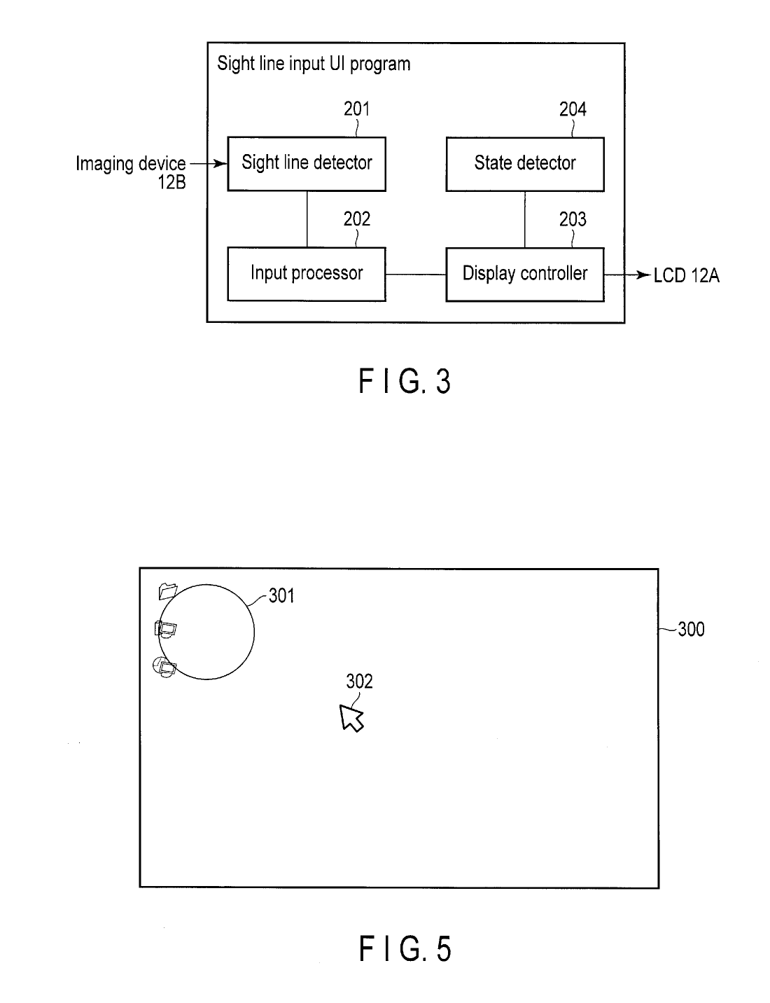

FIG. 3 shows a functional structure of the sight line input UI program. The sight line input UI program includes a sight line detector 201, an input processor 202, a display controller 203 and a state detector 204. In the present embodiment, each of these modules 201 to 204 is a function execution module implemented by executing the sight line input UI program by a computer (for example, CPU 111) of the electronic apparatus 10. All or a part of each of the modules 201 to 204 may be implemented by hardware such as an integrated circuit (IC) or may be implemented as a combinational structure of software and hardware.

The sight line detector 201 detects a sight line of the user by analyzing an image that is captured by the imaging device 12B and includes the user's eyes, and specifies a position (hereinafter referred to as a sight line position) on the screen of the LCD 12A (display) corresponding to the detected sight line.

When the sight line input UI is in a state of accepting input by a sight line of the user, the input processor 202 accepts the sight line position specified by the sight line detector 201 as input by the sight line of the user.

When the input by a sight line of the user is accepted by the input processor 202, the display controller 203 displays a cursor (hereinafter referred to as a sight line input UI cursor) at the sight line position (on the display screen) accepted as the input. The sight line input UI cursor is one of the elements constituting the sight line input UI, and is operated based on (movement, etc., of) a sight line of the user to give various instructions to the electronic apparatus 10. It is assumed that the sight line input UI cursor can be operated independently of an operation to the user interface of the OS. More specifically, the sight line input UI cursor is independent of a cursor (hereinafter referred to as a mouse cursor) operated by means of an OS-standard pointing device such as the touchpad 14 and the mouse, and does not interfere with an operation to the mouse cursor. In the description below, the user interface of the OS to accept input by the pointing device such as the touchpad 14 and the mouse is referred to as a pointing UI.

The state detector 204 detects a state of the sight line input UI. For example, the state detector 204 detects whether an instruction to the electronic apparatus 10 according to an operation to the sight line input UI cursor can be accepted or not, whether an instruction to the electronic apparatus 10 according to an operation to the sight line input UI cursor has been accepted or not, etc., as the state of the sight line input UI.

The state of the sight line input UI thus detected by the state detector 204 is notified to the user by changing a display mode of the sight line input UI cursor.

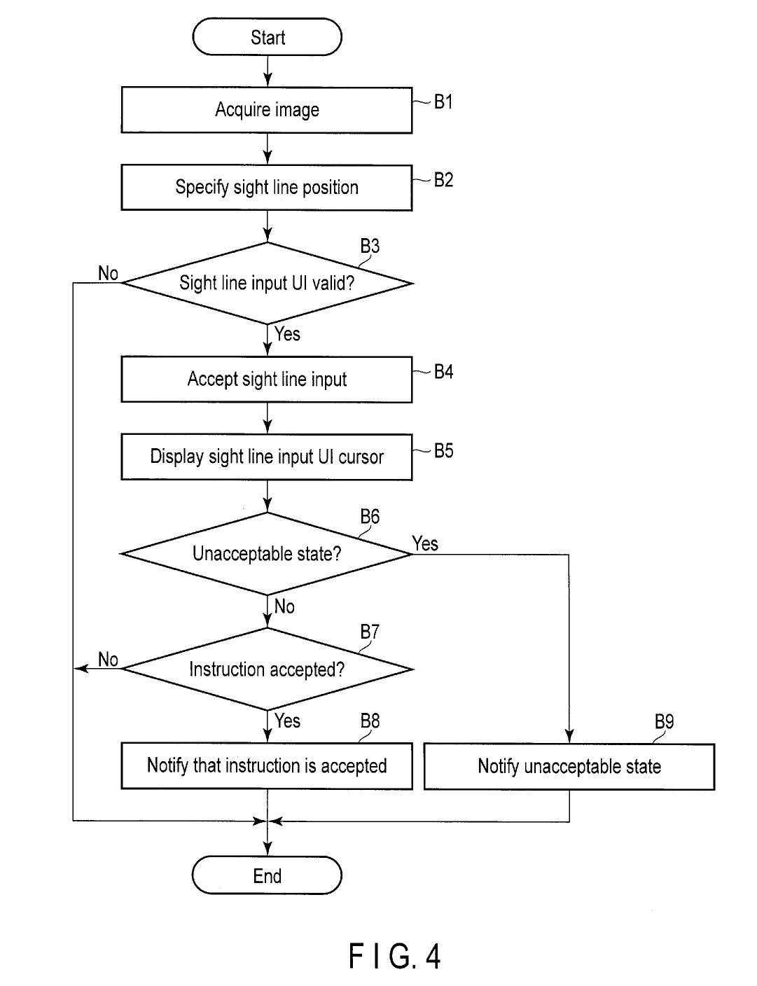

Next, a procedure in the case where the sight line input UI is provided in the electronic apparatus 10 of the present embodiment is described with reference to a flowchart of FIG. 4.

First, the sight line detector 201 acquires an image captured by the imaging device 12B (block B1). The image acquired by the sight line detector 201 may be any image if the image includes at least the eyes of the user using the electronic apparatus 10. For example, the image may include the entire face of the user or only a part of the face of the user.

Next, the sight line detector 201 detects a sight line (direction) of the user by analyzing the acquired image and specifies a position (sight line position) on the display screen corresponding to the detected sight line (block B2).

More specifically, when an infrared camera is used as the imaging device 12B, the imaging device 12B captures an image while the user's face (eyes) is irradiated by infrared light from, for example, an infrared LED. In this case, for example, by using a position on the cornea of reflected light generated by the infrared light (i.e., corneal reflection) in the image captured by the imaging device 12B as a fiducial point and using the pupil in the image as a moving point, the sight line detector 201 can detect a direction of a sight line of the user based on a position of the moving point with respect to the fiducial point.

The sight line detector 201 can specify the sight line position based on a direction of the detected sight line of the user and a distance between the user's eyes and the imaging device 12B.

The case of using the infrared camera as the imaging device 12B is described, but a visible light camera may be used as the imaging device 12B. In this case, for example, by using an inner corner of the eye in an image captured by the imaging device 12B (visible light camera) as a fiducial point and using the iris as a moving point, the sight line detector 201 can detect a direction of a sight line based on a position of the moving point with respect to the fiducial point and can specify the sight line position.

When the user is not present at a position where an image including the user's eyes can be captured by the imaging device 12B, i.e., when a sight line (direction) of the user cannot be detected, the following processing is not executed.

In the electronic apparatus 10 of the present embodiment, “valid” and “invalid” can be set to the sight line input UI. When “valid” is set to the sight line input UI, the sight line input UI is in a state of accepting input by a sight line of the user (hereinafter referred to as sight line input). In contrast, when “invalid” is set to the sight line input UI, the sight line input UI is in a state of not accepting sight line input. For example, the setting of “valid” and “invalid” may be executed in response to a predetermined operation by the user or may be automatically switched in response to activation, stop, etc., of a predetermined application program.

The imaging device 12B may be configured to operate only when “valid” is set to the sight line input UI. In this case, the above processing in blocks B1 and B2 is executed only when “valid” is set to the sight line input UI.

When activation of the imaging device 12B requires time, the imaging device 12B may be configured to continuously operate while the electronic apparatus 10 is operating, regardless of the setting of “valid” or “invalid” of the sight line input UI.

The input processor 202 determines whether “valid” is set to the sight line input UI (i.e., whether the sight line input UI is valid) or not (block B3).

When the input processor 202 determines that the sight line input UI is not valid (i.e., invalid) (NO in block B3), the processing is ended.

In contrast, when input processor 202 determines that the sight line input UI is valid (YES in block B3), the input processor 202 accepts a sight line position specified by the sight line detector 201 as sight line input (block B4).

When the sight line input (sight line position) is accepted by the processor 202, the display controller 203 displays a sight line input UI cursor at the sight line position (block B5). That is, in the present embodiment, the sight line input UI cursor is displayed when a sight line of the user is detected by the sight line detector 201 and the sight line input UI is valid.

The sight line input UI cursor is hereinafter described in detail with reference to FIG. 5. FIG. 5 shows an example of the display screen on which the sight line input UI cursor is displayed.

As shown in FIG. 5, a sight line input UI cursor 301 is displayed at a position (sight line position) corresponding to a sight line of a user on a display screen 300. For example, the sight line input UI cursor 301 has a semitransparent circular shape of a predetermined size. The user can thereby visually identify various icons even if the icons overlap the sight line input UI cursor 301 on the display screen 300. It should be noted that the size of the sight line input UI cursor 301 is defined to roughly include an error of the sight line position.

When the sight line input UI cursor 301 is thus displayed on the display screen 300, the user can understand that the sight line input UI is valid and can confirm the sight line position (i.e., a range recognized as a sight line of the user by the sight line input UI).

As shown in FIG. 5, the sight line input UI cursor 301 is displayed as a cursor exclusive to the sight line input UI and different from the mouse cursor 302 which can be operated by means of the touchpad 14, the mouse, etc. The sight line input UI cursor 301 can be operated independently of the mouse cursor 302 (i.e., an operation to the pointing UI of the OS).

In other words, the sight line input UI operates independently of the pointing UI of the OS without being restricted by functions, other modes, etc., provided by the OS, until an instruction (operation) is given to the electronic apparatus 10 via the sight line input UI. More specifically, for example, even in the case where another application program operates in the electronic apparatus 10, the sight line input UI cursor 301 is displayed and the user can operate the sight line input UI cursor 301 when “valid” is set to the sight line input UI.

Returning to FIG. 4, the state detector 204 can detect a state (hereinafter referred to as an unacceptable state) in which an instruction to the electronic apparatus 10 cannot be accepted in response to an operation to the sight line input UI cursor 301 as a state of the sight line input UI. The unacceptable state is detected based on, for example, whether the sight line input UI executes other processing or not or a state of the electronic apparatus 10 (system or application program).

Whether the unacceptable state is detected by the state detector 204 or not is determined (block B6).

When the unacceptable state is not detected, i.e., when the sight line input UI can accept an instruction to the electronic apparatus 10 (NO in block B6), the user can give an instruction to the electronic apparatus 10 by operating the sight line input UI cursor 301 displayed on the display screen 300 in accordance with a sight line of the user.

More specifically, when the user changes the position (direction) of the sight line on the display screen 300, the above-described processing B1 to B5 is repeated and the sight line input UI cursor 301 can be moved on the display screen 300 in accordance with the sight line. For example, a pop-up to notify a newly arriving e-mail is assumed to be displayed on the display screen 300. In this case, when an operation to move the sight line input UI cursor 301 to a position overlapping the pop-up on the screen 300 and to maintain a state where the sight line input UI cursor 301 and the pop-up overlap each other for a predetermined time is executed, an instruction to the electronic apparatus 10 to display the detail of the newly arriving e-mail is accepted in the sight line input UI. This instruction to the electronic apparatus 10 is just an example and another instruction to the electronic apparatus 10 may be accepted.

In the case where the setting of “valid” and “invalid” of the sight line input UI is automatically switched as described above, the setting of the sight line input UI may be switched from “invalid” to “valid” when the pop-up is displayed on the display screen 300.

Furthermore, for example, an instruction to the electronic apparatus 10 may be accepted in response to a combination of an operation to the sight line input UI cursor 301 (i.e., the sight line input UI) and an operation to the mouse cursor 302 (i.e., the pointing UI). More specifically, after a predetermined operation to the sight line input UI cursor 301, the mouse cursor 302 may be displayed in the sight line input UI cursor 301 and the user may operate the mouse cursor 302.

Generally, in the sight line input UI, it is easy to specify a position on the display screen 300 but it is difficult to give an instruction to the electronic apparatus 10 equivalent to a click, etc., of the touchpad 14, the mouse, etc. In contrast, for example, in a user interface (hereinafter referred to as a voice input UI) to accept input by the user's voice, it is difficult to specify a position on the display screen 300 but it is easy to give an instruction to the electronic apparatus 10. Therefore, an instruction to the electronic apparatus 10 may be accepted in response to a combination of a sight line and voice operations, for example, by specifying a position on the display screen 300 via the sight line input UI and then giving an instruction to the electronic apparatus 10 via the voice input UI.

Next, whether the above-described instruction to the electronic apparatus 10 has been accepted in the sight line input UI or not is determined (block B7).

When it is determined that the instruction to the electronic apparatus 10 has been accepted (YES in block B7), the display controller 203 notifies the user that the instruction has been accepted by changing the display mode of the sight line input UI cursor 301 (block B8). In this case, the display controller 203 notifies that the instruction to the electronic apparatus 10 has been accepted by, for example, decreasing transparency of the semitransparent sight line input UI cursor 301 for a certain time. It should be noted that the display controller 203 may change, for example, the shape or color of the sight line input UI cursor 301 since it is only necessary to allow the user to understand that the instruction to the electronic apparatus 10 has been accepted.

The notification that the instruction to the electronic apparatus 10 has been accepted (i.e., the state where the display mode of the sight line input UI cursor 301 has been changed) may be maintained for a certain time, and cancellation of the instruction may be accepted while the notification is maintained. The instruction to the electronic apparatus 10 can be cancelled in combination with another UI (mouse, keyboard, gesture or the like). More specifically, the instruction to the electronic apparatus 10 can be cancelled by pressing an escape key provided on the keyboard 13, moving the mouse cursor 302 into the sight line input UI cursor 301 and right-clicking by means of the touchpad 14 or the mouse, etc.

In this case, the change of the display mode of the sight line input UI cursor 301 in block B8 notifies that the instruction to the electronic apparatus 10 has been accepted and that the instruction can be cancelled.

When the unacceptable state is detected in block B6 (YES in block B6), the controller 203 notifies the user of the unacceptable state by changing the display mode of the sight line input UI cursor 301. In this case, the display controller 203 notifies the unacceptable state by displaying, for example, a mark of an hourglass in the sight line input UI cursor 301. It should be noted that the shape, color, etc., of the sight line input UI cursor may be changed since it is only necessary to allow the user to understand the unacceptable state. The display mode of the sight line input UI cursor 301 to notify the unacceptable state is different from the display mode of the sight line input UI cursor 301 to notify that the instruction to the electronic apparatus 10 has been accepted.

There may be an error between the sight line position detected by the sight line detector 201 and a position on the display screen 300 that the user actually looks at. Therefore, the electronic apparatus 10 of the present embodiment has a function of calibrating a position (hereinafter referred to as a display position of the sight line input UI cursor 301) at which the sight line input UI cursor 301 is displayed. The display position of the sight line input UI cursor 301 is calibrated by using a calibration value computed by the processing described below.

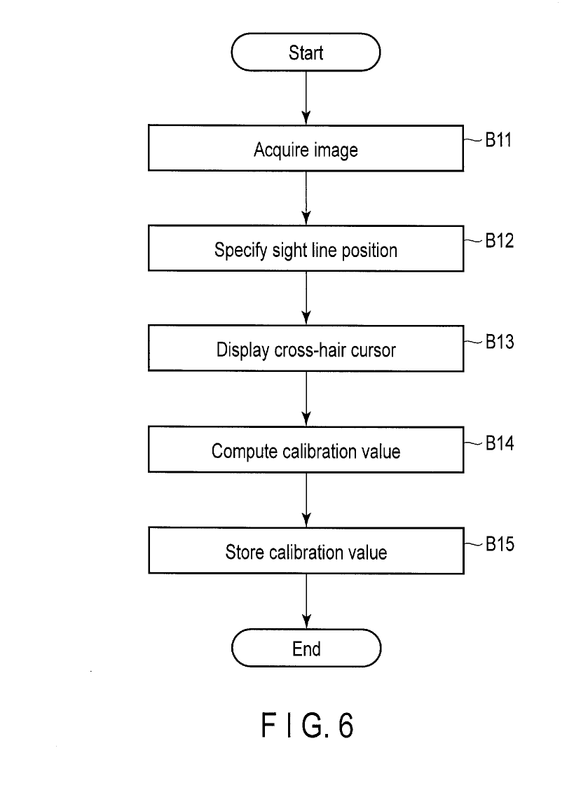

A procedure to compute the calibration value is described with reference to a flowchart of FIG. 6. The processing shown in FIG. 6 is executed, for example, in response to an instruction by the user.

First, the imaging device 12B captures an image including the user's eyes looking at, for example, the mouse cursor 302 displayed on the display screen 300. The sight line detector 201 acquires the image captured by the imaging device 12B (block B11).

The sight line detector 201 detects a sight line of the user by analyzing the acquired image and specifies a position (sight line position) on the display screen 300 corresponding to the detected sight line (block B12). Since the processing in block B12 is the same as the processing in block B2 shown in FIG. 4, the detailed description is omitted.

Next, the display controller 203 displays a cross-hair cursor for calibration at the sight line position specified by the sight line detector 201 (block B13).

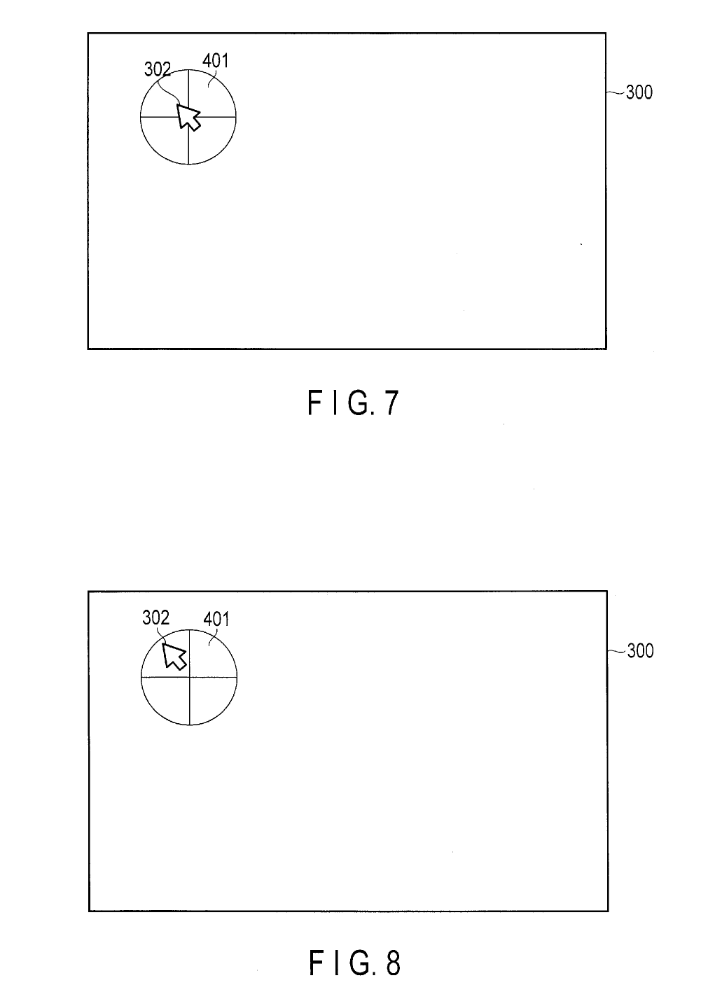

Since the user is looking at the mouse cursor 302, a position of the center point of a cross-hair cursor 401 displayed in block B13 corresponds to a position of the mouse cursor 302 as shown in FIG. 7, when there is no error between the sight line position specified by the sight line detector 201 and the position on the display screen 300 that the user is actually looking at.

In contrast, when there is an error between the sight line position specified by the sight line detector 201 and the position on the display screen 300 that the user is actually looking at, the position of the center point of the cross-hair cursor 401 does not correspond to the position of the mouse cursor 302 as shown in FIG. 8. In this case, the display position of the sight line input UI cursor 301 must be calibrated.

When an operation such as a click is executed by means of the touchpad 14, the mouse or the like, the display controller 203 computes a coordinate difference on the display screen 300 between the sight line position specified by the sight line detector 201 (i.e., the center point of the cross-hair cursor 401) and the position of the mouse cursor 302 as the calibration value.

The calibration value computed by the display controller 203 is stored in the display controller 203 (block B15).

According to the above processing shown in FIG. 6, a difference between coordinates defined by the user by means of the touchpad 14, the mouse or the like (i.e., coordinates input via the pointing UI) and coordinates of the sight line position recognized in the sight line input UI can be computed as the calibration value.

In the case where the calibration value thus computed is stored in the display controller 203, the calibration value is applied to the sight line position detected by the sight line detector 201 when displaying the sight line input UI cursor 301 in the processing of block B5 shown in FIG. 4. The display position of the sight line input UI cursor 301 can be thereby calibrated.

In the above description, the user looks at the mouse cursor 302 when the processing shown in FIG. 6 is executed. However, when the processing shown in FIG. 6 is executed, a predetermined mark may be displayed at a predetermined position on the display screen 300 (for example, the center of the screen 300) and the user may look at the predetermined mark. In this case, a coordinate difference between the sight line position detected by the sight line detector 201 and the center point of the display screen 300 may be acquired as the calibration value.

As described above, in the present embodiment, a position on the display screen 300 corresponding to a sight line of a user is accepted as input by the sight line of the user, and the sight line input UI cursor 301 operated based on the sight line of the user is displayed at the detected position on the display screen 300. In the present embodiment, a state of the sight line input UI (first user interface) is notified to the user by changing the display mode of the sight line input UI cursor 301. In this case, for example, at least one of a shape, a size and transparency is changed as the display mode of the sight line input UI cursor 301. The state of the sight line input UI notified to the user includes a state where an instruction to the electronic apparatus 10 according to an operation to the sight line input UI cursor 301 cannot be accepted, a state where an instruction to the electronic apparatus 10 according to an operation to the sight line input UI cursor 301 has been accepted, etc.

According to such a structure, in the present embodiment, the user can easily understand which position on the screen is accepted as input by the sight line of the user or whether the desired operation (instruction) has been correctly accepted.

It should be noted that the state of the sight line input UI to be notified to the user described in the present embodiment is just an example, and another state may be notified to the user by changing the display mode of the sight line input UI cursor 301.

In the present embodiment, the sight line input UI cursor 301 can be operated independently of an operation to the pointing UI (second user interface) of the operating system which runs on the electronic apparatus 10 (for example, an operation to the mouse cursor 302). That is, since the sight line input UI of the present embodiment is independent of the pointing UI and does not interfere with operations of the OS, the modeless sight line input UI can be implemented and an operation (instruction) can be executed via the sight line input UI without interrupting various works executed in the electronic apparatus 10.

In the present embodiment, for example, even if an unintended instruction is accepted via the sight line input UI, the instruction can be cancelled by a structure in which the cancellation of the instruction is accepted in response to an operation to the pointing UI while the notification that the instruction to the electronic apparatus 10 has been accepted is maintained.

In the present embodiment, the operability in the electronic apparatus 10 can be further improved by the structure in which an instruction to the electronic apparatus 10 is accepted in response to a combination of an operation to the sight line input UI cursor 301 and an operation to the pointing UI (i.e., an operation to the mouse cursor 302).

In the present embodiment, the sight line input UI cursor 301 can be displayed at an appropriate position according to a sight line of the user by the structure in which the display position of the sight line input UI cursor 301 is calibrated by means of the pointing UI.

In the present embodiment, the electronic apparatus 10 is mainly implemented as the notebook personal computer. However, the electronic apparatus 10 may be implemented as, for example, a tablet computer including a touch panel. In this case, the sight line input UI cursor can be operated independently of an operation to a user interface (touch UI) using the touch panel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising a first user interface to accept input by a sight line of a user, comprising:
a display; and
a circuitry configured to accept a position on a screen of the display corresponding to the sight line of the user as the input, and display a cursor operated based on the sight line of the user at the accepted position on the screen,
wherein
the cursor is configured to be operated independently of an operation to a second user interface of an operating system which runs on the electronic apparatus,
the circuitry is further configured to notify a state of the first user interface by changing a display mode of the cursor.

2. The electronic apparatus of claim 1, wherein
the circuitry is further configured to notify the state of the first user interface by changing at least one of a shape, a size and transparency of the cursor.

3. The electronic apparatus of claim 1, wherein
the state of the first user interface comprises a state where an instruction to the electronic apparatus according to an operation to the cursor is unacceptable or a state where an instruction to the electronic apparatus according to an operation to the cursor has been accepted.

4. The electronic apparatus of claim 3, wherein
while notifying the state where an instruction to the electronic apparatus has been accepted, the circuitry is further configured to accept cancellation of the instruction in response to an operation to the second user interface.

5. The electronic apparatus of claim 1, wherein
the circuitry is further configured to accept an instruction to the electronic apparatus in response to a combination of an operation to the cursor and an operation to the second user interface.

6. The electronic apparatus of claim 1, wherein
the circuitry is further configured to calibrate the position at which the cursor is displayed by using the second user interface.

7. A method executed by an electronic apparatus comprising a first user interface to accept input by a sight line of a user, comprising:
accepting a position on a screen of a display corresponding to the sight line of the user as the input;
displaying a cursor operated based on the sight line of the user at the accepted position on the screen; and
notifying a state of the first user interface by changing a display mode of the cursor,
wherein
the cursor is configured to be operated independently of an operation to a second user interface of an operating system which runs on the electronic apparatus.
